(19) United States
(12) Patent Application Publication
(10) Pub. No.: US 2004/0170852 A1
(43) Pub. Date: Sep. 2, 2004

(54) Multilayer breathable microporous film with reinforced impermeability to liquids and production method

(76) Inventor: Bo Gustafson, Lund (SE)

Correspondence Address: MCCARTER & ENGLISH LLP, CITYPLACE I, 185 ASYLUM STREET, HARTFORD, CT, 06103, US

(21) Appl. No.: 10/275,201

(22) PCT Filed: May 3, 2001
(86) PCT No.: PCT/FR01/01351

(30) Foreign Application Priority Data
May 3, 2000 (FR) 00/05641

(51) Int. Cl. B32B 27/32

(52) U.S. Cl. 428/500

(57) ABSTRACT

The invention concerns a process for producing a polyolefin film having a combination of properties, specifically water vapor permeability and demonstrating reinforced liquid impermeability, said process comprising the steps of:

coextrusion from a die of polyolefinic polymers and/or copolymers mixtures one of which at least contains inorganic fillers forming a precursor film;

stretching of the precursor film to form a breathable multilayer film,

which is characterized in that said precursor film is a base multilayer film having at least two contiguous layers of same composition, having at the structure “B”-“B”, optionally associated to at least one layer having a different composition from the two contiguous layers “B”-“B”, and having a specific characteristic.

### FIELD OF THE INVENTION

The invention relates to a process for producing a microporous film, which is permeable to gas and more particularly to water vapor, and having a reinforced impermeability to liquids.

More particularly, the invention concerns a process for producing a microporous film, which is permeable to gas and more particularly to water vapor, and which demonstrates a reinforced impermeability to liquids, that is to say without having any loss of its impermeability property to liquids, by coextrusion of thermoplastic compositions constituted of olefinic polymers and/or copolymers mixtures and of particulate fillers, said film comprising at least two adjacent layers of same composition, used such as, or associated for example by coextrusion with at least a third layer of a different composition, said layer having a specific composition.

This invention concerns also a breathable film, which is permeable to gas and more particularly to water vapor, and with reinforced impermeability to liquids, as well as laminates that associate said film to at least one non woven fabric and disposable hygiene articles such as diapers for children, incontinent adults or feminine hygiene articles, as well as disposable garments, implementing the microporous film and/or the laminate, as well as for building applications.

### BACKGROUND OF THE INVENTION

Continuous homogenous films made from polymers are naturally impervious to liquids and water vapor: they act as a real barrier against those materials.

When these barrier films are used as a components of sanitary disposable articles, such as diapers for children or incontinent adults, or even for feminine hygiene articles, they can induce skin rash as moisture cannot leak out from the article when used. That is why, a real search for more comfort has triggered the development in the field of films intended at diapers for children, incontinent adults and for feminine hygiene articles, focusing on the film breathability, on its soft textile touch, more particularly for the backsheet.

Several processes have been developed, to produce polymeric films which are impermeable to liquids but permeable to water vapor (gas permeability), with a high water vapor transmission rate.

Most of these processes led to the production of breathable films (because of their permeability to gas) implementing either one or the other of the means allowing the physical creation of a micro-porosity in said films, or using specific polymers, such as hydrophile polymers, which sometimes also demonstrate water vapor permeability, depending upon their chain structures which facilitate both water vapor absorption and gas transfer.

Concerning the micro-porosity of the films produced according to known methods, it can be manufactured by numerous methods including for instance mechanical micro perforation.

However, the mostly used method for producing microporous films, consists,

in a first step, in extruding (or blown extruding) a mixture of polymers and inorganic fillers, in the form of a precursor film, then

in a secondary step (or in line), in subjecting this precursor film, to a stretching process, in a longitudinal and/or transversal direction, at a temperature lower than the one of the melting point of the polymers mixture, in order to generate a multiplicity of pores or micro-holes.

Such pores (or micro-holes) are of sufficiently small diameters to prevent liquids from passing through while allowing the transfer of gas (water vapor) at moderate to very high transmission rates.

The properties of such films, based on polyolefins, indicate that the processes and the raw materials play a key role in determining their final properties: micrographs obtained from electronic microscope illustrate for example, the differences in the shape and in the dimension of the pores of the films stretched uniaxially or biaxially or even in the occurrence of micro-tears, and point out the origin and the nature of the occurrence of tears.

The analytical method which consists of determining the water vapor transmission rate is a means to measure the breathability of a film, that is to say the mass or the volume of gas transferred across the thickness of the film, for a given unit of surface and by time unit, in well-defined environmental conditions.

However, the breathable films which are impermeable to liquids can have a monolayer or, more recently a multilayer structure.

Microporous monolayer films are well known in the field of hygiene products, such as diapers for children, incontinent adults or feminine hygiene articles. They are used in disposable products structures, in association with other components, specifically as backsheet.

These monolayer films can be manufactured by blown or cast extrusion, of a loaded polymer in order to produce a precursor film, followed by a stretching process of this precursor film, according to one or two directions (biaxially), then by a thermal stabilization step, thus creating micro-holes which will trigger the breathability of the film. Such films may also be embossed before or after the stretching step. Said films are used as such in the hygiene products but can be assembled with a non woven for the same application.

Examples of such monolayer microporous films have been described in several documents.

The U.S. Pat. No. 4,829,096 describes a breathable microporous liquid which is impermeable to liquids, as well as its manufacturing process.

This process consists in the preparation of a mixture comprising a low density linear polyethylene and an inorganic filler, and optionally a surfactant agent, then the forming of a precursor film by known means, specifically the monolayer extrusion and ultimately the stretching of the precursor film (mono- or bi-axial stretching), in order to give to the film its microporous character.

The films thus conceived find their applications in different domains, including leisure ware, sportswear, clothing, feminine hygiene products, disposable babies diapers, disposable sanitary products for incontinent adults . . .

The EP patent 0232060 describes as well a manufacturing process for a microporous, water vapor permeable yet liquid impermeable film according to different steps consisting of the preparation of a mixture comprising olefinic polymers, (homo- and copolymers), and a mineral filler, the extrusion of the mixture, in order to achieve a precursor film, the embossing of said precursor film, then its stretching, according to at least a mono axial direction. Such films demonstrate a porosity as a result of the creation of micro-pores initiated during the film stretching and resulting from the quantity and the size of the mineral filler loading, of the stretching ratio and of other mastered or non mastered factors. In another embodiment, the embossing step can be duplicated after stretching. The embossing is claimed to give a greater porosity to the film and simultaneously bring a softer touch to the film.

The international patent application WO 98/05501 describes a film having high water vapor porosity (permeability), but also demonstrating other attributes not known to the art such as extreme low thickness for the film allowing film lightness, as well as a softer touch for said film. These performances are possible by the use of metallocene-origin polyethylene polymers. Said film is produced by extrusion of a mixture constituted of these metallocene polyethylenes and inorganic fillers, forming as previously described a precursor film, which is subjected to a stretching operation according to at least one direction.

Microporous multilayer films are known as well and can be used in different application fields.

Multilayer films may be manufactured by a prior extrusion of each layer, followed by their assembly by lamination, or even by coextrusion of the different polymer compositions, in order to constitute the different co-extruded layers, one at least comprising a mineral filler, thus creating a multilayer precursor film.

This precursor film is then subjected to a stretching operation according to at least one direction, usually in the machine direction, in order to create the microporosity in the layer comprising the mineral filler.

Examples of such microporous multilayer films have been described in several documents.

The patent application WO 98/58799 describes a breathable multilayer film obtained by coextrusion, followed by a stretching step, which comprises at least three layers, these at least three layers being:

a core layer made of filled polyolefin, made microporous during stretching,

two external layers, positioned on each side of the core layer, made of polar polymers and/or copolymers, that is to say hydrophiles, naturally permeable to water vapor, the thickness of external layers being small, of at most 2 μm, while the impermeability of the films to liquids is essentially insured by the filled polyolefin core layer.

The patent application WO 99/29499 describes as well a breathable multilayer film, obtained by coextrusion, followed by a stretching step, which comprises at least two layers which are,

a layer formed of an unfilled hydrophile polymer or copolymer, chosen among the group of polyamides, polyesters, polyurethanes having a capacity to transmit the water vapor, this layer becoming a core layer in a three layers structure;

at least another layer, designated as skin or external layer, composed of a filled polyolefin made microporous by a stretching step, the liquids impermeability being insured by the layer made of the unfilled hydrophile polymers and/or copolymers.

The patent application WO 97/04955 describes as well a breathable multilayer film obtained by coextrusion of five layers having the structure “C”-“A”-“B”-“A”-“C”, followed by a stretching step, these different layers being:

the core layer “B” formed preferably of a filled polyolefin, made microporous during the stretching step,

the two external layers “C”, formed of hydrophilic polymers or copolymers, having natural capacities to transmit water vapor,

the two intermediate layers “A”, which are bond layers between layers “B” and “C”, these layers “A” being formed of a polymer composition compatible with the ones of the other layers.

However, all these mono- or multilayer processes have in common a disturbing characteristic, which appears more and more in microporous films, because such films are designed to be thinner and thinner. This specificity consists in the occurrence of a loss of the “impermeability to liquids” property.

Micro-tearing of said microporous film can occur during a high stretching step. Such accidental events, even restricted to specific zones of the breathable film are disturbing, as the breathable film can not anymore meets its property of absolute barrier to liquids.

Accidental micro tears occur on monolayer films as well as on multilayer films, as in this last case, such accidents take place in the core layer which is generally the filler layer which is made microporous by stretching, and propagate in the thickness of the film, the external layers, too thin, not having the sufficient mechanical strength to resist to the hydrostatic pressure resulting from the micro tear of the core layer.

Although quality control procedures exist and can be implemented, and which can detect these micro tears, such procedures are costly and not 100% pertinent.

These micro-tearings may be initiated by a filler particulate of too large size or by agglomeration of particles, or even by a “gel” originating from the crosslinked polymer particles, realized during the film manufacturing or already present in the polymer before its implementing.

“Gels” can also have other origins such as for example, cross contaminations between polymers of different fluidity index.

“Gel” formation is a well known phenomenon which is

inherent to polymer manufacturers,

or which occurs in the extruder during the extrusion process. This phenomenon is not totally mastered today, even by the persons skilled in the art deploying the best practices.

The micro tears may also be initiated by more or less large voids, present in the precursor film, as a result of gaseous emissions (even minor) which take place during the extrusion process or of air initially present, entrapped in the extruded material.

Voids appearing during the extrusion process often results from:

a too high temperature which may more or less degrade the polymer material with the emission of volatile materials,

or even vaporization of liquids present in minor amount in the melt polymer material,

or finally, initially entrapped air in the polymer material and released during the extrusion process.

Upon stretching step of the film, these voids will become approximately elliptic-shaped gaseous volumes and will induce at best a film thinning and at worst a full film tearing.

More precisely, depending upon the particulate filler used, the particles size of this filler, the dispersion of these particles in the polymer material, there may be a risk to see the stretched film becoming not only microporous to water vapor but also becoming permeable to liquids, as a result of the creation of pores of too large diameters and of micro tearing.

### OBJECT OF THE INVENTION

The purpose of the invention is to eliminate these above mentioned drawbacks.

All along the description of the object of the invention, the gas permeability in general of the film will be referred to as water vapor permeability of said film.

It is a first object of the invention to implement a method for manufacturing a film demonstrating reinforced, or total, impermeability to liquids, yet water vapor permeable, which can be manufactured at high production rates and uses polyolefins as component materials of the different layers.

It is a further object of the invention to implement said method for manufacturing a film demonstrating reinforced impermeability to liquids, yet water vapor permeable, which leads to a reduction in the quantity of defects of the film, which is at the origin of the loss of impermeability.

It is a further object of the invention to implement said method for manufacturing a film demonstrating reinforced impermeability to liquids, yet water vapor permeable, used as such or associated with a multilayer structure in a coextrusion process or other.

It is a further object of the invention to implement said method for the manufacture of a film with reinforced impermeability to liquids, yet water vapor permeable, by means of specific surfaces, in order to incorporate adhesion means for the subsequent assembly of said multilayer liquid impermeable and water vapor permeable film with other structures such as for example non woven fabrics.

It is a further object of the invention to optimize the water vapor transmission rate for the final structure, while reinforcing liquids impermeability of the film.

It is a further object of the invention to realize on said manufacturing method of a water vapor permeable film, of reduced thickness, according to the market requirements, which will not lose its impermeability property to liquids.

It is a further object of the invention to manufacture, according to said process a thin film, with reinforced impermeability to liquids and water vapor permeable film resisting however sufficiently to the tear with a sufficient tear resistance to which may be used as such, as backsheet of diapers for children, incontinent adults and of hygiene feminine articles, or assembled by lamination onto a non woven fabric, the resulting laminated product being used as backsheet of diapers for children, incontinent adults and of feminine hygiene articles, or still associated with a multilayer structure by a coextrusion process or other, used as such as backsheet of diapers for children, incontinent adults and of hygiene feminine articles, or assembled by lamination onto a non woven fabric, the resulting laminated product being used as backsheet of diapers for children, incontinent adults and of feminine hygiene articles, as well as for disposable garments, or films for building applications, for the films of greater thickness.

### SUMMARY OF THE INVENTION

All the purposes of the invention described above can be reached when implementing the process according to the invention.

Thus, the invention concerns a process for producing a multilayer polyolefinic film, having simultaneously the properties of being water vapor permeable and of having a reinforced impermeability, or even a total impermeability to liquids, said process comprising the steps of:

coextrusion from a die of polyolefinic polymer and/or copolymer mixtures, which one at least contains mineral fillers, forming a precursor film;

stretching of the precursor film to form a breathable multilayer film,

characterized in that:

said precursor film is a base multilayer film, comprising at least two contiguous layers of same polyolefinic composition, having as a minimum the structure “B”-“B”.

Thus, the invention concerns a process for producing a multilayer polyolefinic film, having simultaneously the properties of being water vapor permeable and of having a reinforced impermeability, or even a total impermeability, to liquids, said process comprising the steps of:

coextrusion from a die of polyolefinic polymer and/or copolymer mixtures, which one at least contains mineral fillers, forming a precursor film;

stretching of the precursor film to form a breathable multilayer film,

characterized in that said precursor film is a base multilayer film, comprising at least two contiguous layers of same polyolefinic composition, having at least the structure “B”-“B”, associated to at least another layer of different composition from at least the two contiguous layers “B”-“B”.

The invention concerns a process for producing a multilayer polyolefinic film, having simultaneously the properties of being permeable to water vapor and of having a reinforced impermeability, or even a total impermeability, to liquids, that is to say not having any loss of its property of impermeability to liquids, said process comprising the steps of:

coextrusion from a die, of at least two contiguous layers of same polyolefinic composition comprising mineral fillers forming a multilayer base film having at least the following structure “B”-“B”, with at least one layer having another specific property to form a precursor film of at least three layers, having as a minimum, the following structure “A”-“B”-“B” or “C”-“B”-“B” where “A” is a specific skin layer, “B” is a base layer and “C” is a specific skin/adhesion layer;

stretching of the multilayer precursor film to form a multilayer film, permeable to water vapor without loss of its property of impermeability to liquids.

The invention further concerns a thin film with a multilayer structure, water vapor permeable, without loss of its property of impermeability to liquids, used alone as well as assembled by lamination with a non-woven fabric, and used as backsheet for disposable sanitary articles for children, incontinent adults and for feminine hygiene articles, or garments.

### DETAILED DESCRIPTION OF THE INVENTION

According to the invention, the extrusion step, in which is formed the precursor film, comprises the simultaneous coextrusion of at least two contiguous layers of same composition, having the minimum structure “B”-“B”, representing at most 100% of the film total thickness.

According to the invention, the extrusion step during which the base film “B”-“B” is formed, can comprise the simultaneous coextrusion of at least three layers two layers of which at least “B”-“B”, are adjacent and of same composition, the at least third layer, of different composition from the composition of the contiguous “B”-“B” layers, being chosen among “A” or “C” layers.

The thickness of the different layers is expressed in percentage of the total thickness of said breathable multilayer film and are as follows:

for the contiguous base layers “B-“B”, of about 40% to about 95% of cumulated thickness of the two layers,

for the at least third layer, the thickness varies between 5% to 60% of the total thickness of the breathable film.

When the breathable film comprises at least four layers, among which the two “B”-“B” layers, the two other layers being chosen among the layers “A” and “C”, the base film “B”-“B” has the same thickness as previously described, while the layer “A” and “C” have each a thickness varying between about 5% to about 30% of the total thickness of the breathable film.

Said “A”, “B” and “C” layers are entirely composed of polyolefinic polymers, the elastomer entering into the composition of certain layers, being itself preferably selected among those of olefinic origin.

### Contiguous Base Layers “B”-“B”

According to the invention, the contiguous base layers “B”-“B”, which are coextruded and are to become microporous by stretching, have a composition which comprises at least one polyolefinic homopolymer and/or copolymer and at least a particulate filler, and eventually one or several polyolefin-based elastomers.

These homo- or copolymers are selected from the group consisting of polyethylenes, homo- and/or copolymers, preferably linear low density polyethylene and/or homo- and/or copolymers polypropylenes.

When high pressure polymerized homo- and/or copolymers polyethylenes, or when low-pressure high density polyethylenes are used, they are chosen among those having a density comprised in the range of 0.915 to 0.965 (norm ASTM 1505), and preferably within the lowest density range of 0.915 to 0.935.

Concerning low density linear polyethylenes, they have a density comprised between 0.890 and 0.940 and can be chosen among the group of copolymers of ethylene and alpha olefinic comonomers like C₄ to C₁₀. They can be obtain for example by a catalysed polymerization with a catalyst such as metallocene or according to other methods. These co-monomers in C₄ to C₁₀ are chosen preferably among the group comprising butene-1, pentene-1, hexene-1, 4 methylpentene-1, heptene-1, and octene-1.

The propylene polymers, homo- or copolymers, include homopolymers of propylene, copolymers of propylene with ethylene, copolymers of propylene with C₄ to C₁₀ alpha-olefinic comonomers. For the propylene copolymers, one or more alpha-olefinic comonomers can be used. The copolymers of alpha-olefinic propylene can have an alpha-olefin content comprised between 0.1% and 40% by weight, and preferably between 1 and 10% by weight.

When polypropylene copolymers are used, they are preferably chosen among the group of ethylene-propylene copolymers.

The contiguous base layers “B”-“B” polymers and/or copolymers are chosen in such a way that their fluidity index is comprised between 0.2 and 15.0 g/10 min when measured according to the standards of 2,16 kg, a temperature of 190° C. for polyethylenes and 230° C. for polypropylenes under standard orifice size (norm ASTM D1238).

For the cast process the fluidity index ranges from 0.8 to 15.0 g/10 min, and for blown process from 0.2 to 10.0 g/10 min.

However the contiguous base layers “B”-“B” are preferably made from low density linear polyethylenes (copolymers of ethylene and of alpha olefins).

All of these polymers or copolymers may contain slip agents and antiblock agents, as well as antioxidant and stabilization agents.

The contiguous base layers “B”-“B” according to the invention are formulated so as to incorporate from 30% to 80% by weight of particulate filler and preferably from 40% to 55% by weight of particulate filler from the cumulated amount of particulate filler and polymer material.

These particulate fillers are well known to the art and may be any inorganic or organic material having a low affinity for water, naturally or after appropriate treatment, and demonstrate a rigidity as opposed to elasticity for the polymer material.

Organic particulate fillers can comprise for instance high melting point and/or high viscosity polymers and of particles size is compatible with the stretching step of the process. Such polymers are for instance ultra-high molecular weight high density polyethylenes, polypropylenes, polyamides, polyesters, polyurethanes.

Inorganic particulate fillers can comprise metal salts, such as, barium carbonate, calcium carbonate, magnesium carbonate, magnesium sulfate, barium sulfate, calcium sulfate; metal hydroxides, such as, aluminium hydroxide, magnesium hydroxide; metal oxides, such as, calcium oxide; magnesium oxide; titanium oxide; titanium dioxide and zinc oxide; or particulate materials such as clay, kaolin, talc, silica, diatom earth, alumina, mica, glass powder, and zeolites.

Inorganic particulate fillers are preferably chosen among the group constituted from calcium carbonate, barium sulfate, silica, alumina, kaolin, and talc.

Calcium carbonate is particularly preferred for its low cost, whiteness, inertness, and availability.

The inorganic particulate fillers (such as calcium carbonate) can be surface treated to be hydrophobe and to improve binding of the filler to the polymer. A preferred coating is stearic acid reacting with the calcium stearate which is used for food contact, but other coatings are possible.

It can be desirable to surface treat the inorganic fillers in order to obtain a optimum dispersion in the polymer material and to avoid any agglomerates (they can form a particulate aggregate inducing the occurrence of holes during the stretching step). This can be done thanks to a surface treatment or by incorporating in the polymer material a dispersing agent such as alkyl phosphates, alkyl phosphonates, alkyl sulfates, alkyl sulfonates or analogues (possibly oxyethylated).

Although content of particulate fillers introduced into the contiguous base layers “B”-“B” was already mentioned, reasons for limiting this percentage by weight, as already mentioned, should be further considered.

Indeed, the amount of particulate fillers added to the polyolefins depends on the desired properties of the breathable film, which should include, among others, tear-strength, sufficient water vapor transmission rate, and sufficient stretch-ability. However, it is believed that a film cannot be sufficiently breathable when produced with an amount of fillers inferior to about 30% by weight of the polyolefins/fillers composition. Thus, a minimum of 30% fillers by weight is required to insure the creation of a useful micro-porosity of the film when stretched. Moreover, it is believed that films cannot be implemented with an amount of the fillers superior to about 80% by weight of the polyolefins/fillers composition, because higher amounts of fillers may cause difficulties in the mixture and significant losses in strength for the final breathable film.

Consequently particulate fillers are used in the composition of layers according to the invention, is comprised between about 30% and 80% by weight, in relation to the cumulated amount of polymer material and of the filler.

The particulate fillers average diameters implemented in the invention are chosen between 0.5 and 5 microns, and preferably between 0.8 and 2.2 microns for the contiguous base layers “B”-“B”, for films having a thickness comprised between 20 and 100 microns before stretching.

Polyolefin materials and the fillers according to the invention can be mixed in different known ways.

According to the invention, the elastomers implemented in the contiguous base layers “B”-“B” are chosen among the group constituted from ethylene-propylene rubber (EPR), ethylene-propylene-diene modified rubber (EEPDM), styrene-butadiene-styrene (SBS), styrene-ethylene-butadiene-styrene (SEBS), styrene-butadiene rubber (SBR), optionally partially or completely crosslinked, styrene-isoprene-styrene (SIS), butyl rubber (BR), nitrile-butyl rubber (NBR), hydrogeno-nitrile-butyl rubber (HNBR), and polyvinyl acetate (AP); or used in accordance with a mixture (either in a reactor or by extrusion) of polyethylene and/or semi-crystalline propylene with at least another elastomer, such as, for example, polyethylene/ethylene-propylene rubber (PE/EPR), polyethylene/ethylene-propylene-diene modified rubber (PE/EPDM). It is also possible that the elastomeric fraction is optionally partially or completely crosslinked, or belong to the group of polypropylenes (homopolymers) with amorphous and semi-crystalline blocks and copolymers of propylene/ethylene or alpha-olefin with amorphous and semi-crystalline blocks.

All of these polymers or copolymers can be prepared by introduction of several agents, such as slip and antiblock agents, antioxidant and stabilization agents.

According to the invention, the contiguous base layers “B”- “B” can be used to recycle scrap material multilayer collected from the process either before or after stretching, or potentially after assembly steps. The content of recycled materials in the core layer “B” can vary from 0% to 50% by weight and is preferably comprised between 0% and 25% by weight.

### Association of the Base Film “B”-“B” with Other Layers by Coextrusion Process

As previously mentioned, according to the invention, the coextrusion step during which the base precursor film “B”-“B” is formed, can comprise the simultaneous coextrusion of at least three layers with at least two contiguous layers of identical composition, having at least the structure “B”-“B”, and another layer at least of a different composition from the layers “B”, possibly chosen among the layers “A” and “C” described, as specific layers.

This other specific layer is specific in the sense that it possesses unique properties, such as soft touch, adhesion, assembly conditions, breathability, ability to enhance the extrusion results, in regards to die related problems.

The current market evolution leads to more and more demanding functionality for such liquids impermeable breathable films, comprising a soft textile touch, and an ability to be assembled to non woven fabrics. As these microporous films are in most cases not very extensible, and have a low tear resistance, they are often combined with another substrate (such as for instance a non woven fabric).

According to the invention, the microporous specific skin layer “A” comprises at least one polyolefinic copolymer having an E modulus inferior to 50 mPa (ASTM 882)′. This copolymer is chosen among the group consisting of ethylene based polar copolymers and/or grafted polyolefinic polymers.

Such polar copolymers and grafted polyolefinic polymers demonstrate crystallinity levels different to the versions of the homopolymers crystallinity: they present higher water vapor transfer ability and improved softness properties for the considered skin layer “A”.

Gas or water vapor permeability of said specific layer “A” is measured by water vapor transmission rate (expressed in g/m²/24 hours at a specific temperature and a specific relative humidity, for example at 38° C. and 90% for a given thickness).

Softness touch properties are measured by an E modulus which must be inferior to 50 mPa, (when tested according to the tactile testing ASTM D 882).

Said polar ethylene copolymer implemented in the realisation of the specific layer “A” is a copolymer composed of ethylene and of at least one polar co-monomer chosen among the group consisting of family of vinyl esters, family of acrylic and methacrylic acids and their esters.

Preferably, the polar co-monomer can be chosen in the group consisting of vinyl acetate, vinyl propionate, acrylic and methacrylic acids and their esters, such as acrylates having 4 to 8 carbon atoms such as methyl acrylate, ethyl acrylate, n-propyl acrylate, isopropyl acrylate, n-butyl acrylate, t-butyl acrylate, isobutyl acrylate, and methacrylates having 4 to 8 carbon atoms such as methyl methacrylate, ethyl methacrylate, n-propyl methacrylate, isopropyl methacrylate, n-butyl methacrylate, t-butyl methacrylate, and isobutyl methacrylate. One or more of these co-monomers can be used simultaneously.

Copolymers of ethylene and of at least one polar co-monomer are formed of at most 30% by weight of comonomers. A content of co-monomer superior to 30% by weight co-polymerized with ethylene results in odor and adhesion problems.

Copolymers of ethylene and of at least one polar co-monomer should have a fluidity index comprised in the range of 1 to 15 g/10 min in standard conditions (MFI NORME ASTM D 1238-2.16 kg-at 190° C.).

Grafted polyolefinic polymers implemented in the realisation of specific layer “A” can be manufactured by chemical grafting by means of acrylic acid, methacrylic acid, maleic anhydride and alkyl acrylates or methacrylates in which the alkyl is a C1 to C8 hydrocarbon chain.

Fluidity index of such grafted polymers is in the same range as previously mentioned polar copolymers.

All of these polymers or copolymers may contain slip and antiblock agents as well as antioxidant and stabilization agents.

According to the invention, the specific skin and bonding layer “C”, which will become microporous during the stretching, comprises at least one bonding agent of adhesion and/or one homopolymer and/or one thermoplastic polyolefinic copolymer and a particulate filler.

These polyolefinic polymers are selected from the group consisting of polyethylenes and preferably of low density linear polyethylene, and/or polypropylenes, and/or copolymers of ethylene-propylene and of ethylene and of alpha olefin.

Said microporous specific skin and bonding layer “C” polyolefinic homo- and/or copolymer components are linear low density polyethylenes, of density comprised between 0.880 and 0.940, copolymers of ethylene and of alpha olefinic comonomers such as C₄ to C₁₀ and/or a crosslinked high pressure polyethylene of density comprised between 0.915 and 0.965 and preferably between 0.915 and 0.935 and/or a polypropylene, and a copolymer of propylene and ethylene preferably chosen among a group of random block copolymers.

According to the invention, the adhesive/bonding agent present solely in the specific skin and bonding layer “C” is chosen among the group of polar or non polar comonomer/ethylene copolymers, or polar or non polar comonomer/propylene copolymers and/or grafted homo- or copolymers (ethylene or propylene based).

Non polar copolymers can be chosen among the group of elastomers, described previously for the contiguous base layers “B”-“B”. The adhesive/bonding agent is introduced into the composition about 2% to 20% and preferably 5% to 15% by weight.

Polar copolymers can be chosen among the group described previously in the specific skin layer “A”.

According to the invention, the specific skin and bonding layer “C” further comprises from 30% to 80% by weight of particulate fillers and preferably from 45% to 55% in weight of particulate fillers.

These various fillers previously listed for the adjacent base layers “B”-“B”, comprise organic and mineral fillers but preferably chosen among the group mineral fillers consisting of calcium carbonate, barium sulfate, silica, alumina, kaolin, talcum, and very preferably calcium carbonate. The particulate fillers average diameters are chosen between 0.2 and 3 microns, and preferably between 0.8 and 1.5 microns for the specific skin and bonding layer “C”, so as to reflect the thin gauge at the end of the specific layer “C”.

As previously described, the mineral filler can be surface treated or associated with a dispersing agent.

The addition of white TiO₂ (or other pigments) is possible in any of the considered layers “A”, “B” or “C”.

All such polymers can be formulated according to known methods for an improved heat stabilization.

### Coextrusion Process and Method for Making a Multilayer Breathable Film

The base multilayer precursor film is coextruded through the die, when considering a cast process, and is fixed on the cooling roll by means of a vacuum box and/or air knife. The base multilayer precursor film is subsequently reheated and stretched between at least two rolls systems (primary and secondary) of stretching. A thermal stabilization step can be incorporated in the manufacturing line, so as to release stresses created in the film during the stretching step.

When the base precursor film comprising at least two contiguous layers “B”-“B” is associated with at least one other layer, the coextrusion process can be used and conducted in the same manner.

A subsequent printing step and an embossing step of the film can be considered in the invention.

### Coextrusion Process/Cast Film

As said previously, the process consists in:

co-extruding simultaneously at least a base precursor film to at least two layers from a die, whereas said base multilayer precursor film can be associated, during coextrusion to at least one other layer of a different composition, with the following structure: “A”-“B”-“B”, “C”-“B”-“B”, “B”-“B”-“B” or at least four layers of the following structure: “A”-“B”-“B”-“A”, “C”-“B”-“B”-“C”, “A”-“B”-“B”-“C wherein “A” is a specific skin layer, “B”-“B” is the base film, and “C” is a specific skin/bonding layer,

and stretching subsequently said co-extruded multilayer precursor film to thereby form the breathable multilayer film, creating micro porosity in said center layer and said skin layers, wherein said stretching step is conducted and said different layers have been formulated so as to provide the creation of micro porosity which allows the passage of water vapor but fully prevents the passage of liquids.

The association of the base film comprising at least two contiguous layers “B”-“B” to at least another layer, can be also conducted by other known processes, such as extrusion-lamination, in line or during another step.

Conventional methods of making multilayer films or sheets can easily be modified to allow the realization of the invention. Thus, the multilayer film can be realized using a coextrusion line for a thin film by cast (cast film) as well as a blown film coextrusion line (blown cast).

When it comes to the cast film coextrusion process, the melt temperature of the polymer material can be set between about 200° C. and 250° C.

According to the present invention, the base precursor film can be co-extruded and fixed to the mat cooling roll by the means of an air-knife and/or a vacuum box. The precursor multilayer film is rapidly quenched. The temperature of the base precursor film when leaving the cooling roll is set at a temperature between 15° C. and 60° C.

### Blown Film Coextrusion Process (Blown Cast)

The base precursor film can also be manufactured on a blown film coextrusion line.

The melt polymer is extruded through an annular multilayer die, then blown into a bubble which is cooled down by air directed through an air ring.

The melt temperature of the polymer material can be set between 150° C. and 240° C.

The height of the cooling line, (the cooling line corresponds to the change in dry haze resulting from the solidification of the melt polymer) is an important parameter to control. The height of the cooling line is normally set between 10 and 80 cm from the die surface.

The blowing ratio corresponding to the ratio between bubbles diameter and the die diameter is another process parameter to control: this blowing ratio controls the cross direction orientation. This blowing ratio normally varies from about 1.5 to 4.0.

The bubble is further folded to form a flat film, laying down and wound round a roll or slit and wound in the form of two separate rolls.

The line speed is comprised between 20 and 150 m/min for a precursor film of 100 to 20 microns.

The base precursor film is subsequently stretched, similarly to the step described in the extrusion technology of a cast multilayer film.

It is a further object of the invention to eliminate, by degassing during extrusion, the volatile materials and moisture, which upon heat can be released and can lead to a loss of liquids impermeability by formation of vacuum. This degassing step is conducted under vacuum conditions inferior to 200 millibars in each of the extruders.

### Stretching

The highly filled precursor film (as such or associated), when stretched in a controlled manner, yields a microporous film of much thinner gauge, demonstrating the required properties of breathability and of liquids impermeability.

According to the invention, the extrusion and said stretching steps are conducted so that the obtained multilayer microporous film has a thickness at most 40 microns and preferably at most 25 microns, when it is used for hygiene related applications, and up to 60 microns for other applications.

Before being stretched, the base precursor film leaving the cooling roll, is reheated up to the adequate temperature for the stretching step, then stretched to form a breathable multilayer film.

The base precursor film can be stretched by any conventional methods, for example by a mono-axial or bi-axial stretching. Preferably, the precursor multilayer film is stretched in one direction, which is the machine's direction (longitudinal direction).

The stretching takes place between at least two rolls systems running at different rotational speeds in a standard stretching unit. The multilayer precursor film is stretched at a temperature comprised between 20° C. and 95° C., and the stretching ratio is comprised between 1:1.5 and 1:6.

The stretching of the multilayer precursor film can be conducted in one or several steps followed by a possible thermal stabilization step.

As previously mentioned, the stretching rolls systems operate at different rotational speeds, in order to obtain, for instance from a base precursor film of 80 μm, a thinner film of for instance 20 microns, corresponding to a 4:1 mono-axial stretching ratio, depending upon relaxation; the speeds ratio between the roll systems is known as the stretching ratio: this speed ratio is measured between the inlet and outlet roll systems of the stretching zone.

After being stretched, the breathable film is thermally stabilized (by the tensions release) by passing over heated rolls. The thermal stabilization temperatures (set by the stabilization roll systems temperatures) are comprised between 30° C. and 90° C. for polyethylene and 30° C. and 120° C. for polypropylene.

According to the invention, one may implement a quality control system, in order to visually detect defects along the production line. Its objective is to control and quantify the types and number of defects present in the breathable film, and which could, depending on their frequency of occurrence and their typology, lead to a partial or total loss of the impermeability to liquids for the breathable film.

According to the invention, the multilayer breathable film can be subjected to an embossing step after the stretching step: this embossing will give a softer touch and reduce the gloss of the film. This embossing takes place between two rolls set at a temperature of 35° C. to 100° C.

### Film Utilization

According to the invention, the multilayer breathable film (base film as such or associated with at least one other layer) demonstrates a water vapor transmission rate of at least 500 g/m²/24 hours (at 38° C., 90% relative humidity) and preferably between 2000 and 5000 g/m²/24 hours (at 38° C., 90% relative humidity) without loss in its liquids impermeability.

According to the invention, the multilayer breathable film can be used in the realization-making of the backsheet of diapers for children, incontinent adults and of hygiene disposable articles, feminine hygiene articles, as well as disposable garments, or assembled by lamination onto a non woven and used as a laminated product for the backsheet of diapers for children, incontinent adults and of hygiene disposable articles, feminine hygiene articles and disposable garments.

According to the invention, the breathable multilayer film has a thickness inferior to 40 microns and preferably inferior to 25 microns.

In another embodiment, the thickness of the film is much superior and can vary from 40 to 100 microns, such high gauge films being used for applications related to building, such as walls insulation and the roofing.

### EXAMPLES

### Example 1

The invention will be better described through outlining a specific example. This first example concerns the manufacturing of a multilayer microporous film having the structure “B”-“B”-“B”, with liquids reinforced impermeability, that is to say which demonstrates no loss of its liquids impermeability property.

The measure of impermeability to liquids is conducted according to the norm EN 20811-1992.

This method consists of a measure of hydrostatic loss. The measure of the resistance to the passage of water through the breathable film is realized. The film is subjected to a steadily increasing pressure of water on one face, under standard conditions, until penetration occurs in three points. The pressure at which the water penetrates the breathable film at the third place is noted. The water pressure can be applied from below or from above the specimen film to test. The area of breathable film to test is 100 cm².

The water height at which droplets occur is recorded. When one measures the hydrostatic pressure on discreet defect, recorded and well identified on the breathable specimen film to test of 20 microns thickness, one can establish the following correlation presented in table 1.

TABLE 1
Correlation between the defect type and the
height of water column

| | Typology and size | Height of water column |
|---|---|---|
| Breathable film | of defects in mm² | in mm |
| No defect | 0 | Superior to 750 |
| Level 1 | 1-2 | 600 ± 150 |
| Level 2 | 2-100 | 300 ± 150 |
| Level 3 | 100-1000 | 100 ± 50 |
| Holes present | >1000 | 0-50 |

While a non breathable monolithic film will demonstrate much higher values of water column height before it breaks (2 meters or more depending upon the thickness and the material elongation at break), a breathable film will demonstrate an inherent significant reduction of reached water column height.

Scanning cameras coupled with sophisticated software can easily be implemented on such a process designed to manufacture breathable films demonstrating no loss in respect to their liquids impermeability property. The recording is continuous and done across the full film. The listing of defects per type is done by means of an images analysis which corresponds to images integrated and stored in the software. Fast computer response allows the instant reading of the film defects characteristics.

The <<level 1>> defects are optically recorded as having a dimension of 1 to 2 mm² and correspond to dark or white spots, caused by a coarse agglomeration of CaCO₃ or other agglomeration, without lighter and thinner area surrounding these spots. Upon stretching, they will induce a possible tearing.

The <<level 2>> defects are optically recorded as having a dimension of 2 to 100 mm². They correspond to lighter thinner zones surrounding an initiator which can be an agglomerate or a polymer gel, or a vacuum (void) initially present in the mixture and stretched while molten mixture forming the precursor film, and further elongated upon post stretching. These defects will not affect the film strength in transversal direction beyond a 50% limit.

The <<level 3>> defects are optically recorded as having a dimension of 100 to 1000 mm². They also correspond to lighter and thinner zones, surrounding an initiator which can be a larger agglomerate or a larger polymer gel, or a larger vacuum (void), all of them lying down and leading to a local elongation of the molten film and stretched afterwards. For these defects, the tensile strength will be reduced beyond 50%.

It should be pointed out that filters present between the extruder metering zone and the die, at adapter level, does not block the passage of such disturbing particles. A 250 mesh filter blocks 60 microns particles. Increasing filtering capability would be totally detrimental to extrusion output and could induce gel formation which would be counter productive.

The height of water in the hydrostatic water column will exert a further elongation on these defects and will induce breakage at higher or lower water height depending upon defect typology, that is resulting from film thickness, surface area and size.

There is a direct correlation between the water hydrostatic pressure (column height in mm) which can be measured on discreet samples typology, and the defects number per typology per 10000 m² of produced film which can be continuously controlled, by the scanning camera.

In this example, according to the invention, a multilayer microporous film of structure “B”-“B”-“B” which demonstrates no loss in respect to its liquid impermeability property has been produced. The polymer constituting the “B”-“B”-“B” base film is a low density linear <<Dowlex 2035>> in a ratio of 45% formulated with a surface treated calcium carbonate <<Filmlink 520>> in a ratio of 45% and with a 10% addition of recycled materials.

TABLE 2
Structure and components

| | | Base film “B”-“B”-“B” |
|---|---|---|
| Thickness distribution | | 100% equally spread |
| Components | Polymer 1 | 45% of [symbol] Dowlex 2035 [symbol] |
| | Filler | 45% of [symbol] Filmlink 520 [symbol] |
| | Recycled | 10% of “B”-“B”-“B” |
| | materials | |

The recycled material originated from the breathable film edge trims which were densified and reincorporated in the extruders feeding the base precursor film die.

The different materials mentioned in the above example are described below:

The <<Dowlex 2035>> from Dow is an octene-based low density linear polyethylene with a fluidity index of 6,0 g/10 min (MFI ASTM D 1238, 2,16 kg −190° C.) and a density of 0,919;

The <<Filmlink 520>> from English China Clay (ECC) is a calcium carbonate filler (CACO₃), ground under wet process with an average diameter D50 of particles of 2,0 microns. It has a hydrophobe envelope of 1% and an Elrepho (gloss ISO) of 90.

The base precursor film “B”-“B”-“B” is obtained by cast coextrusion. Said film is then fixed on the cooling roll by means of an air knife and a vacuum box. This is also used to eliminate the smoke which occurs during the extrusion process.

The extrusion temperatures are set between 180° C. and 240° C. The adapter temperature is set at 235° C., while the die temperature was set slightly higher. An automatic die is used in order to achieve a specific gauge control. The precision reached is inferior to ±2%. The melt temperature is controlled at 230° C.

The polymers in the three different extruders were strongly degassed, in order to remove all volatile materials or entrapped air present in the polymers, the vacuum being set below 200 millibars.

The base precursor film “B”-“B”-“B” has a final thickness of 80 microns before stretching. It is manufactured at a line speed of approximately 25 m/min. After being stretched to a ratio of 4:1, the resulting breathable film has a thickness of 20 microns and a breathability of approximately 3500 g/m²/24 hours (at 38° C. with a relative humidity of 90%).

As previously explained, it is not possible to give a statistically significant value of the breathable film liquids impermeability behavior, on a comparative basis, but it is quite appropriate to consider the defects which constitutes the real indicator of a property, at a given film thickness.

The table 3 below summarizes this comparison. It gives the number of defects optically on-line measured per typology and for 10000 m² of produced film—i.e. defects occurrence:

TABLE 3
Comparative defects occurrence/tracking

| | | | stretched | |
|---|---|---|---|---|
| | | | breathable film, | Stretched |
| Defects, | precursor | precursor | monolayer | breathable |
| types and | monolayer | base film | structure | film |
| number | film “B” | “B”-“B”-“B” | “B” | “B”-“B”-“B” |
| Film | 80 | 80 | 20 | 20 |
| thickness | | | | |
| (microns) | | | | |
| Holes | 0 | 0 | 3 | 0 |
| Level 3 | 2 | 0 | 8 | 2 |
| Level 2 | 16 | 8 | 64 | 26 |
| Level 1 | 80 | 86 | 66 | 86 |

Such results confirm the performances improvement attributable to the base film concept constituted by two or more contiguous layers of identical composition.

It should be pointed out that the camera reading is made through the entire layer structure. More precisely, the occurrence of defects is statistically distributed among the three contiguous layers “B”-“B”-“B”, or among the two contiguous layers “B”-“B”. These defects correlated to the number of layers, appear much reduced when compared to the amount of defects appearing in the monolayer.

The breathable film is embossed after being stretched and thermally stabilized. This is conducted between two heated embossing rolls which are engraved appropriately. The embossing temperatures are well known to the art. Defects controlling is done before winding.

The multilayer breathable film of the example 1, manufactured according to the invention is used in the making of backsheet of diaper and disposable hygiene articles or assembled onto a non woven and used for laminated backsheet of diapers and disposable hygiene articles, feminine hygiene articles as well as disposable garments.

### Example 2

In another example, the compositions are altered in order to accommodate other functional requirements:

The film produced is a base film “B”-“B” associated by coextrusion to a third specific layer “A”.

TABLE 4
Structure and component

| | | | Associated third |
|---|---|---|---|
| | | Base film “B”-“B” | layer “A” |
| Thickness distribution | | 90% | 10% |
| Components | Polymer 1 | 42% of [symbol] Dowlex | 100% of [symbol] Lotryl |
| | | 2035 [symbol] | 20MB08 [symbol] |
| | Polymer 2 | 8% of block | |
| | | copolymer [symbol] Adflex | |
| | | X102S [symbol] | |
| | Fillers | 50% of | |
| | | [symbol] Filmlink 520 [symbol] | |
| | Recycled | 0 | |
| | materials | | |

The <<Lotryl 20 MB 08>> of ATOCHEM is an ethyl copolymer (methacrylate) with a fluidity index of 8,0 g/10 min (MFI norm measured according to ASTM D 1238-2,16 kg and 190° C.) and a methyl methacrylate content of 20%, formulated with slip and antiblock agents, in order to facilitate the process.

The <<Adflex X 102S>> from MONTELL is a thermoplastic polyolefin polymer, with a fluidity index of 8,0 g/10 min (MFI norm ASTM D 1238 2,16 kg and 230° C.) and a density of 0,890 and a Vicat softening point of 55° C.

The extrusion and subsequent stretching steps are very similar to those described in example 1.

The defects number is of the same order of magnitude as in example 1, highlighting the significance of the base film concept, where considering according to the invention the use of two contiguous layers of identical composition. The presence of <<Adflex X 102S>> results in slightly increased level of defects.

The final breathability is measured at 3000 g/m²/24 hours (at 38° C. under 90% relative humidity).

There was not the slightest build up on the cooling roll because the “A” layer which was in contact with the cooling roll, does not contain any fillers.

This breathable film is used as such, as backsheet for children diapers. The specific skin layer “A” offers a soft touch. The film has been further embossed after stretching.

### Example 3

In this example, the compositions are altered in order to accommodate further functional requirements:

The film produced is a base film “B”-“B” associated by coextrusion to a third layer “C”

TABLE 4
Structure and components

| | | | Associated third |
|---|---|---|---|
| | | Base film “B”-“B” | layer “C” |
| Thickness distribution | | 80% | 20% |
| Components | Polymer 1 | 32% of [symbol] Dow | 38% of [symbol] Borealis |
| | | Elite 5200 [symbol] | BD 801F [symbol] |
| | Polymer 2 | 10% of [symbol] Escorene | 10% of [symbol] Adflex |
| | | 259 [symbol] | X102S [symbol] |
| | Fillers | 50% of | 52% of [symbol] Filmlink |
| | | [symbol] Filmlink 520 [symbol] | 400 [symbol] |
| | Recycled | 0 | |
| | materials | | |
| | Additives | 8% of PP | |
| | | copolymer | |
| | | [symbol] Adflex X102S [symbol] | |

The two contiguous layers “B”-“B” of identical composition are of same thickness. The third layer “C” is associated by coextrusion.

The <<Elite 5200>> from DOW is an octene-based low density linear polyethylene (metallocene catalyst) with a fluidity index of 4,0 g/10 min (MFI norm ASTM D 1238-2,16 kg-190° C.) and a density of 0,917.

The <<Escorene 259>> from EXXON is a branched high pressure low density polyethylene with a fluidity index of 12 g/10 min (MFI norm ASTM D 1238-2,16 kg-190° C.) and a density of 0,915;

The <<BD 801F>> is a polypropylene from BOREALIS.

The <<Filmlink 400>> from ENGLISH CHINA CLAY is a calcium carbonate filler, humid ground (CACO₃) with an average diameter D50 of particles of 1,2 microns. This filler has a hydrophobe coating of 1% and brightness is 90 when expressed in Elrepho (Elrepho of 90).

The conditions of operations realization at the extrusion level as well as at the stretching level are adjusted to suit slight viscosity differences, but remained within a 10° C. range of those described in the example 1.

In another embodiment, the <<Adflex X 102 S>> is replaced by <<Kraton D-2122 compound>> from SHELL a SBS block copolymer, with a fluidity index of 21 g/10 min (MFI norm ASTM D 1238) and of density of 0,930 according to ASTM D 792 norm.

The breathable film demonstrates a breathability of 2000 g/m²/24 hours at 38° C. under 90% relative humidity.

The defects number is comprised within the range mentioned in example 2, that is slightly (10%) higher than the defect number reached in example 1, because of some “gel shower” which results from the presence of block copolymers.

The final breathable film had a thickness of 20 microns after stretching. It has not been stretched but let as such. It has subsequently been assembled onto a non woven, the layer “C” having the required bonding capacity to the considered non woven. The final laminated product is used as backsheet of disposable diapers for children.

In another embodiment, the overall film thickness is of 40 microns after stretching. This was achieved by reducing proportionally the line speed, during the precursor film forming step, while maintaining the stretching ratio to the previous levels. Because of the film thickness increase, the issue of tear initiation, and subsequent loss in liquid impermeability was much less acute.

The film is used for a building application, in association with insulation.

1. A process for producing a multilayer polyolefinic film having simultaneously the properties of being water vapor permeable and of having a reinforced liquid impermeability, said process comprising the steps of:
coextrusion from a die of polyolefinic polymers and/or copolymers mixtures and one of which at least contains inorganic fillers, forming a multilayer precursor film;
stretching of the precursor film to form a breathable multilayer film,
characterized in that said precursor film is a base multilayer film, comprising at least two contiguous layers of same polyolefinic composition, having at least the structure “B”-“B”.

2. A process for producing a multilayer polyolefinic film having simultaneously the properties of being water vapor permeable and of having a liquids reinforced impermeability, said process comprising the steps of:
coextrusion from a die of polyolefinic polymers and/or copolymers mixtures, one of which at least contains inorganic fillers, to form a multilayer precursor film,
stretching of the precursor film to form a breathable multilayer film,
characterized in that said precursor film is a base multilayer film, comprising at least two contiguous layers of same polyolefinic composition, having at least the structure “B”-“B”, associated with at least one other polyolefinic layer having a composition different from that of at least two contiguous layers “B”-“B”.

3. A process for producing a multilayer polyolefinic film with a multilayer structure having simultaneously a combination of the properties, of being water vapor permeable and of having a liquids reinforced impermeability, said process comprising the steps of:
coextrusion from a die of at least two contiguous layers of same polyolefinic composition comprising mineral fillers to form a multilayer base film having at least the following structure: “B”-“B”, with at least one other polyolefinic layer having another specific property in order to form a precursor film of at least three layers having, as a minimum, the following structure “A”-“B”-“B” or “C”-“B”-“B” where “A” is a specific skin layer, “B” is one of the base layers and “C” is a specific skin/adhesion layer.
stretching of the multilayer precursor film to thereby form a water vapor permeable multilayer film, without loss of its liquids impermeability property.

4. A production process according to claim 1, characterized in that the step of coextrusion comprises the simultaneous coextrusion of at least two contiguous layers of same composition, “B”-“B”, representing at most 100% of the film total thickness.

5. A production process according to anyone of claims 2 or 3, characterized in that the step of coextrusion comprises the simultaneous coextrusion of at least three layers, of which two at least “B”-“B” layers are contiguous and of same composition, the at least third layer being chosen among the layers “A” and “C” of polyolefinic composition different from the contiguous layers “B”-“B” for which the thicknesses of the different layers expressed in percentage of the total thickness of the breathable multilayer film are:
for the contiguous base layers “B”-“B”, of about 40% to about 95% of cumulated thickness of two layers,
for the at least third layer, the thickness varies between about 5% to about 60% of the breathable film total thickness.

6. A production process according to claim 5, characterized in that when the breathable film comprises at least four layers among which two contiguous layers “B”-“B” of same composition, the two other layers being chosen among the layers “A” and “C”, each layer “A” and “C” has a thickness varying from about 5% to about 30% of the breathable film total thickness.

7. A production process according to one at least one of the claims 1 to 6, characterized in that the composition of the contiguous layers “B”-“B” comprises at least a homopolymer and/or a polyolefinic copolymer and at least a particulate filler, and possibly one or several polyolefin-based elastomers.

8. A production process according to one at least one of the claims 1 to 7, characterized in that the polyolefinic polymers and/or copolymers constituting the composition of the two contiguous layers “B”-“B” are selected from the group consisting of polyethylenes homo- and/or copolymers, preferably low density linear polyethylenes, and/or polypropylenes homo- and/or copolymers.

9. A production process according to claim 8, characterized in that the polyethylenes homo- or copolymers constituting the composition of the contiguous layers “B”-“B” are chosen within those having a density comprised in the range of 0.915 to 0.965 (norm ASTM 1505), and preferably within the lower density range of 0.915 to 0.935.

10. A production process according to claim 8, characterized in that when low density linear polyethylenes are chosen within those having a density comprised between 0.890 and 0.940, and preferably chosen among th group of copolymers of ethylene and C₄ to C₁₀ alpha olefinic comonomers.

11. A production process according to claim 10, characterized in that the C₄ to C₁₀ comonomers are chosen among the group comprising the butene-1, pentene-1, hexene-1, 4-methylpentene-1, heptane-1, and octene-1.

12. A production process according to claim 8, characterized in that the propylene polymers, homo- or copolymers, are chosen among the group constituted by homopolymers of propylene, copolymers of propylene and ethylene, compolymers of propylene and of C₄ to C₁₀ alpha-olefinic comonomers.

13. A production process according to claim 12, characterized in that the copolymers of propylene and C4 to C10 alpha-olefin have an alpha-olefin content comprised between 0.1 and 40% by weight, and preferably between 1 and 10% by weight.

14. A production process according to one at least of claims 1 to 13, characterized in that the polymers and/or copolymers of the contiguous layers “B”-“B” are chosen in such a way that their fluidity index measured by the “melt flow index” method is comprised between 0.2 and 15.0 g/10 min when measured according to the standards of 2,16 kg, a temperature of 190° C. for polyethylenes and 230° C. for polypropylenes with a standard orifice (norm ASTM D 1238).

15. A production process according to one at least of claims 1 to 14, characterized in that the contiguous layers “B”-“B” comprise at least from 30 to 80% by weight of a particulate filler or mineral or organic origins and preferably from 40 to 55% by weight of the cumulated amount of said particulate filler and the polymer material.

16. A production process according to one at least of claims 1 to 15, characterized in that the elastomers implemented in the contiguous layers “B”-“B” are chosen among the group constituted of ethylene-propylene rubber (EPR), ethylene-propylene-diene modified rubber (EPDMR), styrene-butadiene-styrene (SBS), styrene-ethylene-butadiene-styrene (SEBS), styrene-butadiene rubber (SBR), styrene-isoprene-styrene (SIS), butyl rubber (BR), nitrile-butyl rubber (NBR), hydrogeno-nitrile-butyl rubber and polyvinyl acetate used alone or in mixture with polyethylene and/or semi-crystalline polypropylene.

17. A production process according to claim 16, characterized in that the elastomeric fraction is chosen among the group of polypropylene (homopolymers) with amorphous and semi-crystalline blocks, copolymers of propylene/ethylene or alpha-olefin with amorphous and semi-crystalline blocks.

18. A production process according to anyone of claims 16 and 17, characterized in that the elastomeric fraction is partially or completely crosslinked.

19. A production process according to one at least of claims 1 to 18, characterized in that the contiguous layers “B”-“B” are used to recycle scrap of the multilayer materials collected from the process either before or after stretching or after film assembly.

20. A production process according to claim 19, characterized in that the scrap amount of recycled multilayer materials in the contiguous “B”-“B” layers varies from 0% to 50% by weight, and preferably from 0% to 25%, in relation to said layer.

21. A production process according to one at least of claims 2 to 20, characterized in that the microporous skin layer “A” is formed of at least one ethylene-based polar copolymer and/or of grafted polyolefinic polymer.

22. A production process according to claim 21, characterized in that the polar ethylene copolymer used in the realization of layer “A” is composed of ethylene and of at least a polar co-monomer chosen among the group consisting of family of vinyl esters, family of acrylic and methacrylic acids and their ester.

23. A production process according to anyone of claim 21 or 22, characterized in that the polar ethylenic copolymer comprises at least a comonomer preferably chosen in the group consisting of vinyl acetate, vinyl propionate, acrylic acid, methacrylic acids, methyl acrylate, ethyl acrylate, n-propyl acrylate, isopropyl acrylate, n-butyl acrylate, t-butyl acrylate, isobutyl acrylate, methyl methacrylate, ethyl methacrylate, n-propyl methacrylate, isopropyl methacrylate, n-butyl methacrylate, t-butyl methacrylate, isobutyl methacrylate.

24. A production process according to one at least of claims 21 to 23, characterized in that copolymers of ethylene and at least one polar comonomer have a comonomer content of not more than 30% by weight of comonomers.

25. A production process according to one at least of claims 21 to 24, characterized in that polyolefinic polymers are grafted by means of acrylic acid, methacrylic acid, maleic anhydride, alkyl acrylates and methacrylates in which the alkyl is a C₁ to C₈ hydrocarbon chain.

26. A production process according to one at least of claims 2 to 25, characterized in that the polyolefinic homo- and/or co-polymers of the skin/adhesion layer “C” are chosen among the group of polyethylenes and preferably of low density linear polyethylenes and/or polypropylenes and/or copolymers of ethylene-propylene and of ethylene and of alpha olefins.

27. A production process according to claim 26, characterized in that the polyolefinic homo- or copolymers of the skin/adhesion layer “C” are chosen among the group consisting of low density linear polyethylenes of density comprised between 0.880 and 0.940 of copolymers of ethylene and of alpha olefin comonomers in C₄ to C₁₀, of polyethylenes of density comprised between 0.915 and 0.965 and preferably between 0.915 and 0.935, of polypropylenes and copolymers of propylene and ethylene preferably chosen among the random block copolymers.

28. A production process according to one at least of claims 2 to 27, characterized in that, according to the invention, the adhesive/adhesion agent present in the skin/adhesion layer “C” is chosen among the group of polar or non polar comonomers/ethylene copolymers, of polar or non polar comonomers/propylene copolymers and/or of grafted homo- or copolymers based on ethylene or propylene.

29. A production process according to claim 28, characterized in that polar copolymers are chosen among the group described previously in the skin layer “A”.

30. A production process according to claim 28, characterized in that non polar copolymers are chosen among the group constituted of elastomers, entering in the composition of contiguous layers “B”-“B”.

31. A production process according to one at least of claims 2 to 30, characterized in that the adhesive/bonding agent of the skin/adhesion layer “C” enters in the composition of said layer in a proportion of 2 to 20% and preferably of 5 to 15% by weight, in the considered layer.

32. A production process according to one at least of claims 2 to 30, characterized in that the skin/adhesion layer “C” comprises from 30 to 80% by weight and preferably from 40 to 55% by weight of particulate fillers.

33. A production process according to one at least of claims 1 to 32, characterized in that particulate fillers implemented in the contiguous layers “B”-“B” and in the skin/adhesion layer “C” are of organic and inorganic are chosen in the group consisting of powders-high molecular weight high density polyethylenes, polypropylenes, polyamides, polyesters, polyurethanes, barium carbonates, calcium carbonates, magnesium carbonates, magnesium sulfates, barium sulfates, calcium sulfates; aluminum hydroxide, magnesium hydroxide; calcium oxide; magnesium oxide; titanium oxide; titanium dioxide and zinc oxide; clay, kaolin, talc, silica, diatomaceous earth, glass powder, mica powder, alumina and zeolites and preferably calcium carbonate, barium sulfate, silica, kaolin and talc.

34. A production process according to one at least of claims 1 to 33, characterized in that the particulate fillers implemented in the contiguous layers “B”-“B” and in the skin/adhesion layer “C”, have an average diameter between 0.5 and 5 microns, and preferably between 0.8 and 2.2 microns for the contiguous layers “B”-“B” and an average diameter chosen between 0.2 and 3 microns, and preferably between 0.8 and 1.5 for the skin/adhesion layer “C.

35. A production process according to one at least of claims 1 to 34, characterized in that the multilayer precursor film is obtained by coextrusion through a flat die of a cast film, at a temperature comprised between about 200° C. to 250° C. followed by a cooling at a temperature comprised between 15° C. and 60° C. through an appropriate roll.

36. A production process according to one at least of claims 1 to 34, characterized in that the multilayer precursor film is obtained by coextrusion through an annular die of a blown film (blown cast), at a temperature comprised between about 150° C. to 240° C., followed by a cooling on a line height set between 10 and 80 cm of the die surface with a blowing ratio comprised between 1,5 and 4,0.

37. A production process according to one at least of claims 1 to 36 characterized in that the polymer materials, the fillers and the components intervening in the manufacture of the various layers of the multilayer precursor film are subjected to a drying prior to extrusion.

38. A production process according to one at least of claims 1 to 37, characterized in that the elimination of the volatile materials, humidity and of air contained in the raw materials intervening in the manufacture of the different layers of the multilayer precursor film is achieved by degassing during the extrusion.

39. A production process according to one at least of claims 1 to 38, characterized in that the multilayer precursor film is stretched in the machine direction, in one or several steps, at a temperature comprised between 20° C. and 95° C. and at a ratio between 1:1.5 and 1:6 (measured between the inlet and the outlet of the stretching zone).

40. A production process according to one at least of claims 1 to 39, characterized in that the stretched microporous multilayer film is subjected to an embossing step, at a temperature comprises between 35° C. and 100° C.

41. A production process according to one at least of claims 1 to 40, characterized in that the stretched microporous multilayer film is subjected to an thermal stabilization step at a temperature comprised between 30° C. and 120° C.

42. A breathable microporous multilayer film obtained when implementing the process according to one at least of claims 1 to 41, characterized in that its thickness is at most 40 microns and preferably at most 20 microns for applications in hygiene products.

43. A microporous multilayer film obtained when implementing the process according to one at least of claims 1 to 41, characterized in that its thickness is comprised between 40 microns and 100 microns for applications other than in hygiene products.

44. A breathable microporous multilayer film according to anyone of claims 42 or 43, characterized in that it demonstrates a water vapor transmission rate of at least 500 g/m²/24 hours (at 38° C., 90% relative humidity) and preferably between 2000 and 5000 g/m²/24 hours (at 38° C., 90% relative humidity) without loss in its liquid impermeability.

45. A breathable microporous multilayer film according to one at least of claims 44 to 44, characterized in that it is assembled by lamination with a non woven fabric.

46. Use of the breathable microporous multilayer film according to one at least of claims 42 to 45, as a backsheet of diapers for children, incontinent adults, of hygiene disposable articles, building applications or after assembling with a non woven by lamination, as a laminated product of a diaper for children, incontinent adults, of hygiene disposable articles, disposable garments.
